(19) United States
(12) Patent Application Publication
(10) Pub. No.: US 2012/0098999 A1
(43) Pub. Date: Apr. 26, 2012

(54) IMAGE INFORMATION DISPLAY METHOD COMBINED FACIAL RECOGNITION AND ELECTRONIC DEVICE WITH CAMERA FUNCTION THEREOF

(75) Inventor: YUN-JU CHEN, TAOYUAN CITY (TW)

(73) Assignee: ALTEK CORPORATION, HSINCHU (TW)

(21) Appl. No.: 12/956,564

(22) Filed: Nov. 30, 2010

(30) Foreign Application Priority Data
Oct. 20, 2010 (TW) 099135854

(51) Int. Cl. H04N 5/228; H04N 5/76; G06K 9/00

(52) U.S. Cl. 348/231.5; 348/222.1; 382/118; 348/E05.031

(57) ABSTRACT

The present invention discloses an image information display method combined with facial recognition and an electronic device with camera function thereof. A camera module is used for capturing a plurality of images. A recognition module recognizes the facial features of persons in the image. A touch screen displays the image and a linking icon in an area of the image. While detecting that the link icon is touched, a processing module generates a display command and sends it to the touch screen. Thus, the touch screen shows a flip process and then displays the image information. Therefore, it is more convenient for users to use an electronic device with camera function.

### FIELD OF THE INVENTION

The exemplary embodiment(s) of the present invention relates to an image information display method and an electronic device thereof. More specifically, the exemplary embodiment(s) of the present invention relates to an image information display method combined with facial recognition and an electronic device with camera function thereof.

### BACKGROUND OF THE INVENTION

With the development of technology, a variety of electronic devices have become an indispensable part in everyone's daily life. The development of technology makes people's life more convenient than before. Electronic devices such as cell phone and PDA have been developed to include a variety of functions, such as camera functions, wireless Internet, and multimedia applications. For example, Smartphones have been developed to integrate functions of a camera, cell phone, Internet, and multimedia functionality in one device that is easy to carry.

However, regarding the linkage between the image and the corresponding image information, the present all-in-one Smartphone is still not user-friendly. In general, while browsing saved images in the cell phone, a user can't immediately acquire image information such as persons, time, and location with a simple operation. Therefore, to design an ideal image information display method combined with facial recognition and an electronic device with camera function has become a popular issue in the market.

### SUMMARY

A primary object of the present invention is to provide an image information display method combined with facial recognition and an electronic device with camera function thereof, so as to help users easily access the image information while browsing those images. Thus, the convenience for using the electronic device is improved.

According to an object of the present invention, an electronic device with camera function is disclosed, comprising a camera module, a recognition module, a touch screen, and a processing module. The camera module captures an image. The recognition module recognizes the facial features of at least one person in the image. The touch screen displays the image and a linking icon in an area of the image. The processing module electronically connects to the camera module, the recognition module, and the touch screen. While detecting the linking icon is touched, the processing module generates a display command for the touch screen to display a flip process and the image information.

According to an object of the present invention, an image information display method combined with facial recognition is further disclosed, comprising the following steps: capturing an image by a camera module; recognizing at lease one facial feature of at least one person in the image by a recognition module; displaying the image and a linking icon in an area of the image by a touch screen; generating a display command to the touch screen while a processing module detects that the linking icon is touched; and showing a flip process and displaying the image information on the touch screen according to the display command.

In the present invention, the image information further comprises one part of the image, the name of the folder where the image is saved, the shooting time information, the shooting location information, or the personal information.

In the present invention, the image information further comprises an audio playback icon. While detecting that the audio playback icon is touched, the processing module generates a play command to an audio playback module to play the audio data.

The electronic device with camera function of the present invention further comprises a contact database electrically connected to the processing module. While determining that the personal information hasn't been saved to the contact database, the processing module generates an add-in icon to the person icon on the touch screen.

In the present invention, while detecting that the add-in icon is touched, the processing module saves personal information of the image in the contact database. Thus, users can make a call, text message, and send an email through the contact database.

The image information display method combined with facial recognition and the electronic device with camera function thereof in the present invention have one or more of the following advantages:

(1) The image information display method combined with facial recognition and the electronic device with camera function thereof make it easier for users to acquire the information of the image while browsing images.

(2) The image information display method combined with facial recognition and the electronic device with camera function thereof increase the convenience for users to use an electronic device.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 is a block diagram of an electronic device with camera function according to an embodiment of the present invention.

FIG. 2 is a schematic diagram of the touch screen display of the electronic device with camera function.

FIG. 3A is a schematic diagram of the first flip process of the touch screen display of the electronic device with camera function.

FIG. 3B is a schematic diagram of the second flip process of the touch screen display of the electronic device with camera function.

FIG. 3C is a schematic diagram of the third flip process of the touch screen display of the electronic device with camera function.

FIG. 3D is a schematic diagram of the forth flip process of the touch screen display of the electronic device with camera function.

FIG. 4 is a schematic diagram of the image information display of the electronic device with camera function.

FIG. 5 is a schematic diagram of the person information of the electronic device with camera function.

FIG. 6 is a schematic diagram of the image saved in the specific folder of the electronic device with camera function.

FIG. 7 is a flowchart of an image information display method combined facial recognition in accordance with an embodiment of the present invention.

### DETAILED DESCRIPTION

The present invention will now be described with some preferred embodiments thereof and with reference to the accompanying drawings. For the purpose of easy to understand, elements that are the same in the preferred embodiments are denoted by the same reference numerals.

The electronic device in the present invention could be the digital camera, the built-in camera of a cell phone, or a PDA, digital video device, or any other electronic device with a camera function. To further understand technical features of the present invention, a built-in camera is used as the example but is not limited to this case.

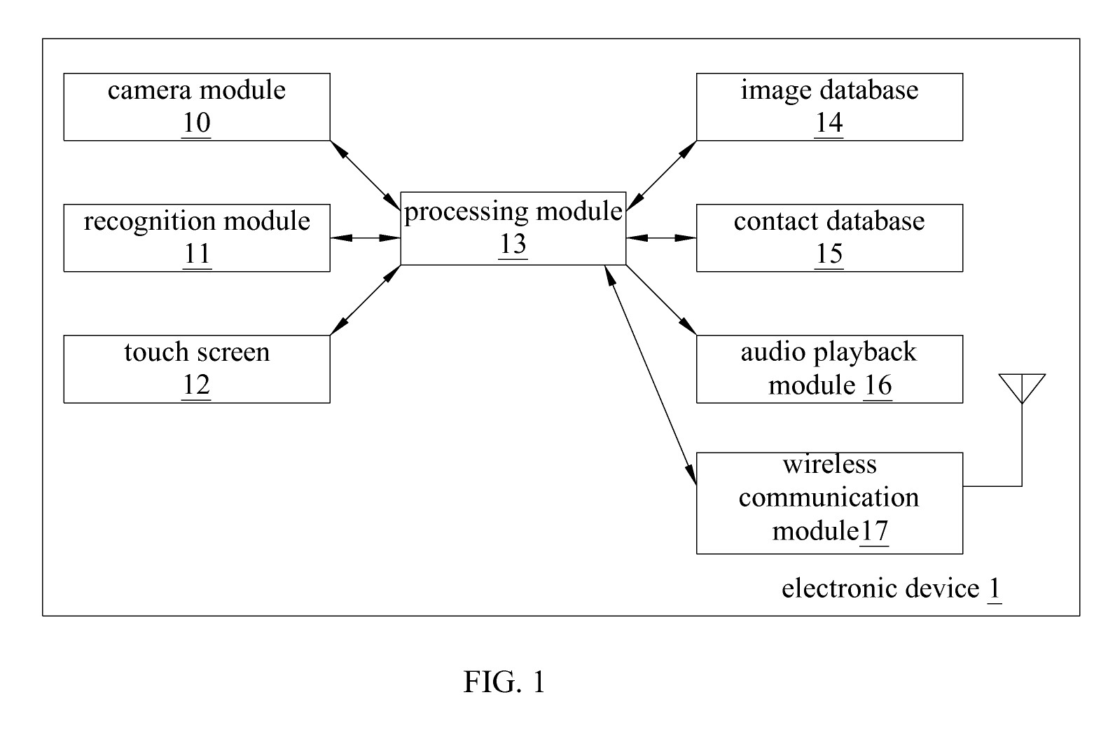

Please refer to FIG. 1. FIG. 1 shows a block diagram of an electronic device with a camera function according to an embodiment of the present invention. As shown, the electronic device 1 with camera function comprises a camera module 10, a recognition module 11, a touch screen 12, a processing module 13, an image database 14, a contact database 15, an audio playback module 16, and a wireless communication module 17. The camera module 10 may comprise a camera lens, a charge-coupled device (CCD) or complementary metal-oxide-semiconductor (CMOS), an analog/digital circuit, an image processor, and so on.

The touch screen 12 is provided to users to choose different functions through a touch method to operate the electronic device 1. Users can use the camera module 10 to capture images. While implementing the camera function, a user may see the scene being shot through the touch screen 12. Further, the image of the scene being shot can also be displayed through the touch screen 12. Therefore, the recognition module 11 can recognize facial features of the image. In the present invention, users can touch the touch screen 12 by hand.

The image database is used for users to save images in the electronic device 1. Users can establish the file folder, set up the name of the file folder, sort out images in the file folder, and then save images in the image database 14.

Users can use the contact database 15 to save contact data such as the facial image (or facial features) and the name, the phone number, and the email of the contact person. In addition, users can use the audio playback module 16 to play audio files (e.g. the audio file of the pop music). The processing module 13 is electronically connected to the camera module 10, the recognition module 11, the touch screen 12, the image database 14, the contact database 15, the audio playback module 16 and the wireless communication module 17. The processing module 13 is used to control the operating process of the electronic device 1. The wireless communication module 17 can connect to at least one base station.

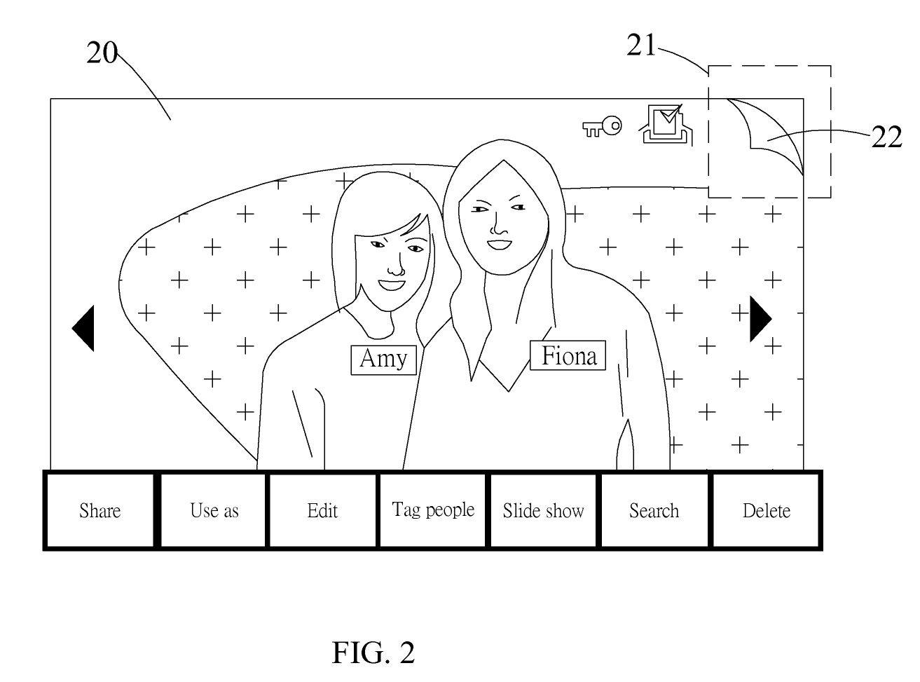

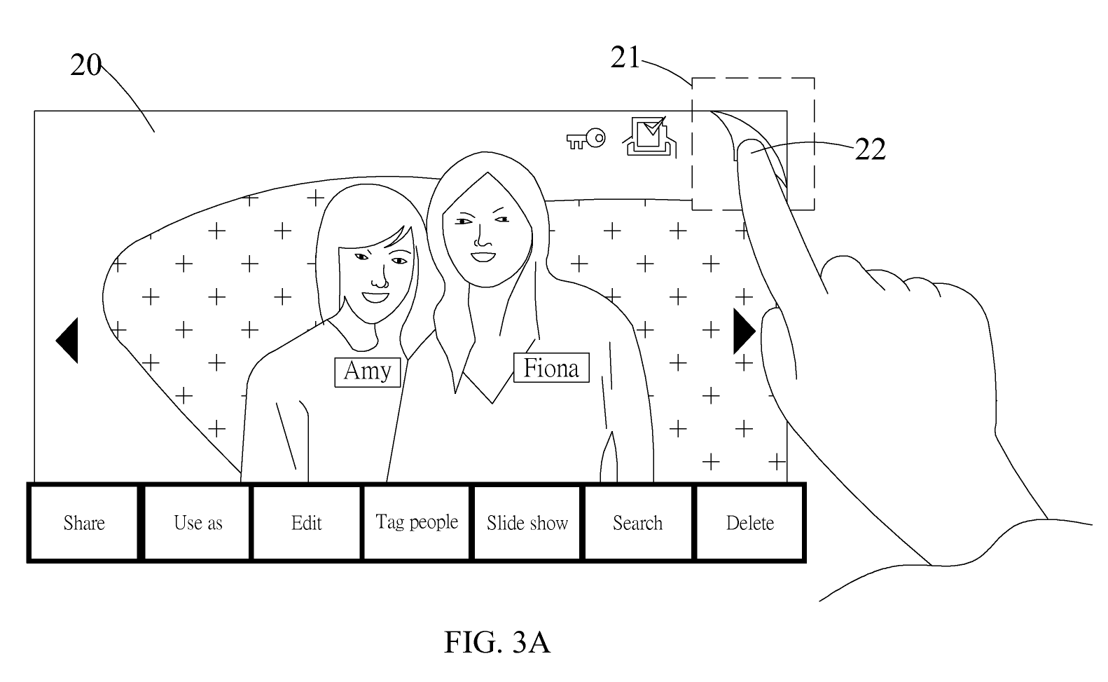

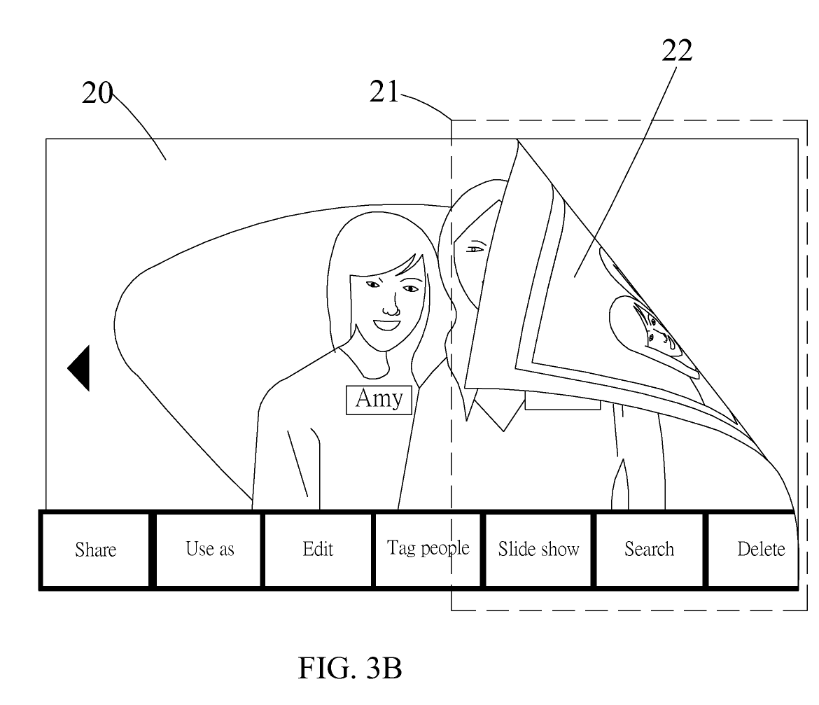

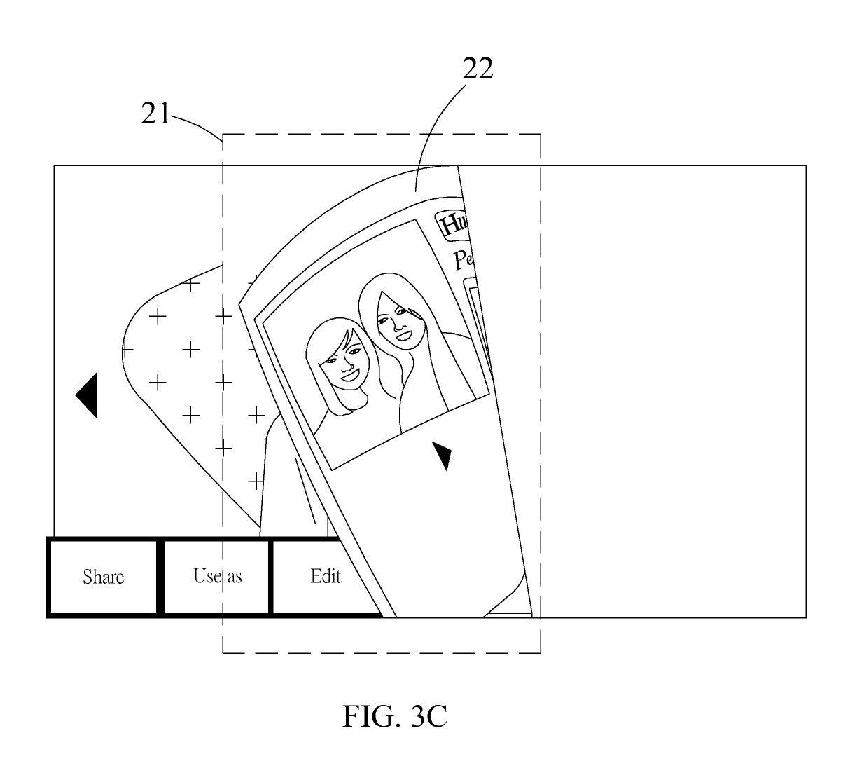

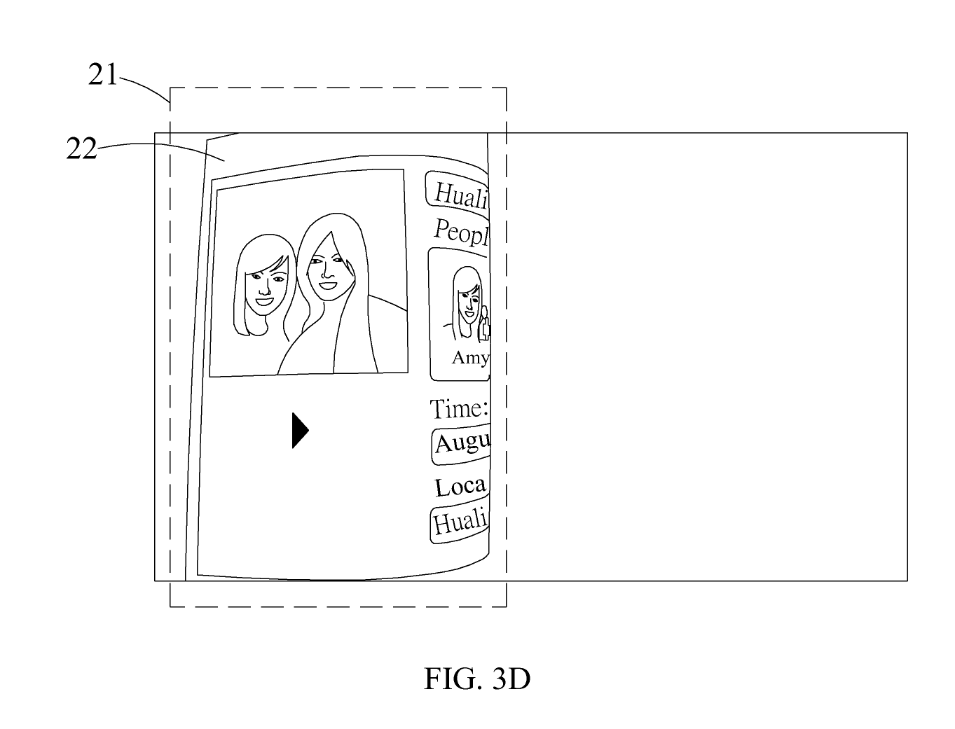

Please refer to FIG. 2. FIG. 2 shows a schematic diagram of the image display of the electronic device with camera function. As shown, the touch screen 12 can display an image 20, and the recognition module 11 can recognize facial features of the image 20 according to special facial features of different people such as eyes, the eyebrow, the mouth, and the face shape. Therefore, based on the recognized facial features from the recognition module 11, the processing module 13 searches the contact person who matches those facial features in the contact database 15 to find the information of the corresponding contact person. If a contact person in the contact database 15 matches those facial features, the processing module 13 can find the corresponding information (e.g. the name, the phone number, and the email) of the contact person. The processing module 13 then generates a person name display command to the touch screen 12 to show the recognized person name of the image 20. As shown in FIG. 2, the processing module 13 determines that facial features of the image 20 correspond to contact persons “Amy” and “Fiona” in the contact database 15 based on the recognized result of the recognition module 11. Thus, the touch screen 12 will display names “Amy” and “Fiona” in the image 20. Moreover, the touch screen 12 can display a linking icon in an area 21 of the image 20. The linking icon can be a page flip icon 22 as the square area in the upper right corner of the FIG. 2 in the embodiment of present invention but the position is not limited. While users click the page flip icon 22 on the touch screen 12, the image 20 will display the page flipping process like the page flipping process shown in FIG. 3A to FIG. 3B respectively.

Moreover, users can add the information of the contact person if the processing module 13 determines that the recognized facial features from the recognition module don't match any contact person in the contact database 15.

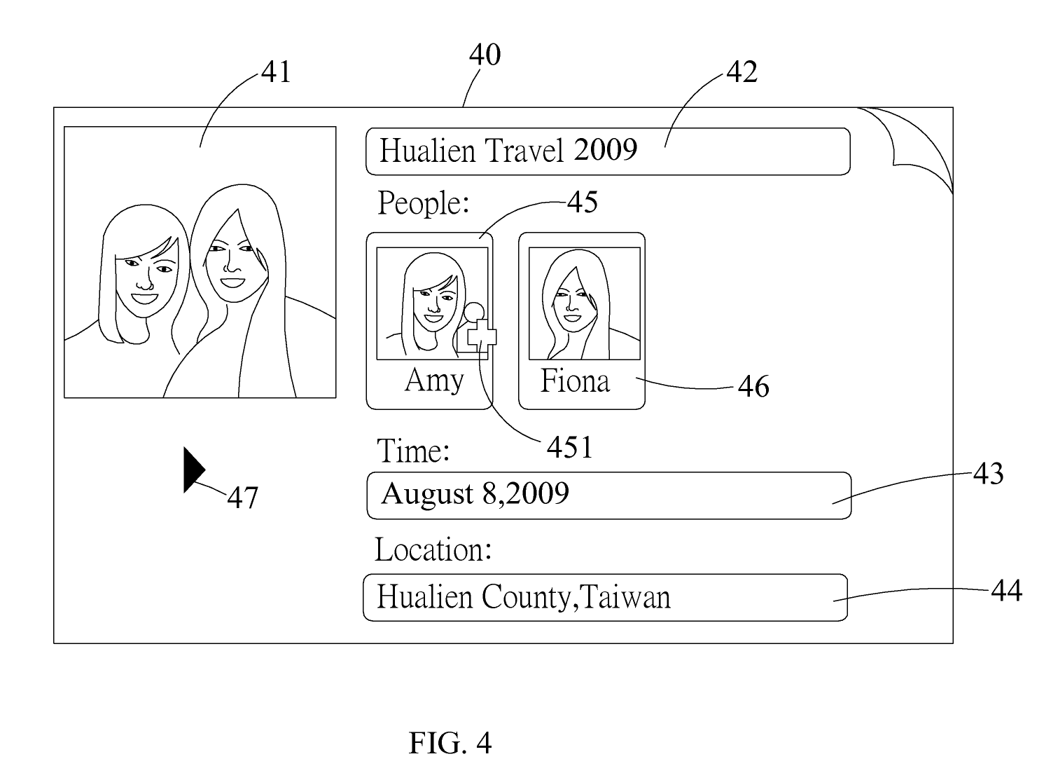

Please also refer to FIG. 4. FIG. 4 shows a schematic diagram of the image information display of the electronic device with camera function. While users want to know more about the information of the browsing image, users can touch the page flip icon 22 in the FIG. 2 and the processing module 13 will detect the first touch signal from the touch screen 12. According to the first touch signal, the processing module 13 later generates a display command to the touch screen 12, and the touch screen 12 will display the page flipping process shown in FIG. 3A to FIG. 3D and a display of the image information 40 shown in the FIG. 4 in the reverse side of the flipped page to show the information of the image 20. The display of the image information 40 comprises a part 41 of the image 20, a folder name 42, a shooting time information 43, a shooting location information 44, a first person information icon 45 or a second person information icon 46.

In the present invention, the part 41 mainly displays the facial image of the image 20. The folder name 42, the shooting time information 43, and the shooting location information 44 are connected to the image database 14. Users will know that the image 20 is saved in a folder in the image database 14 based on the folder name 42. For example, in the FIG. 4, the image 20 is saved in the folder named “Hualian Trip 2009”. While users touch the folder name 42 in the display of image information 40, all of those images saved in the folder in the image database 14 will be showed in the thumbnail format on the touch screen 12. The shooting time information 43 and the shooting location information 44 show the time and location information of the image 20. The person information icons 45 and 46 are connected to the contact database 15. The number of person icons corresponds to the number of persons in the image 20, and when touching the person information icon 45 or 46, users will acquire the person information corresponding to the person icon. A detailed description will be presented in the following. The processing module 13 connects the information of the image database 14 and the contact database 15.

As mentioned above, the processing module 13 will determine whether the recognized facial features from the recognition module 11 match the existing the contact person in the contact database 15. There are two persons in the image 20. If the information of the first person is not saved in the contact database 15, the processing module 13 will generate an add-in command to the touch screen 12 to generate an add-in icon 451 on the first person information icon 45. When detecting that the add-in icon 451 is touched, the processing module 13 will generate an editing command to the touch screen 12. The touch screen 12 then displays an editing image for the new contact. After users have done the information editing of the first person, the processing module 13 saves the information of the first person in the contact database 15.

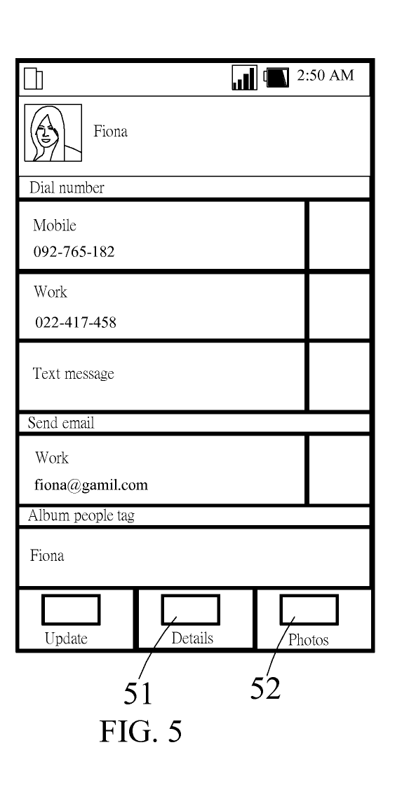

Please also refer to FIG. 5. FIG. 5 shows a schematic diagram of the person information of the electronic device with camera function. While users touch the second person information icon 46 on the display of image information 40, the processing module 13 generates the corresponding command to the touch screen 12, the image database 14, and the contact database 15. The touch screen 12 then displays the information or image regarding the second person of the image 20 in the contact database 15. In the embodiment of this invention, while users touch the second person icon 46 “Fiona” on the display of image information 40 in the FIG. 4, the processing module 13 generates the corresponding command to the touch screen 12 to show the information such as the mobile number, the office number, or the email address in FIG. 5 regarding the second person Fiona in the contact database 15. In addition, if users want to know the detailed information (e.g. birthday), users can click the detailed information icon 51 to acquire more information. If users click the image icon 52 on the personal information interface shown in the FIG. 5, users can further browse all images about the second person Fiona. Besides, the display of image information mentioned above further comprises an audio playback icon 47. When users touch the audio playback icon 47, the processing module 13 will detect the second touch signal from the touch screen 12. Based on the second touch signal of the second person Fiona, the processing module 13 then generates a play command to the audio playback module 16 to play the voice recording previously recorded for the image.

Furthermore, users can touch each area of the display of image information like a part of the image 41, the folder name 42, the shooting tine information 43, the shooting location information 44, the first person information icon 45, and the second person icon 46. The processing module 13 will generate corresponding commands to the touch screen 12 and other related database to show the further display of the link on the touch screen 12.

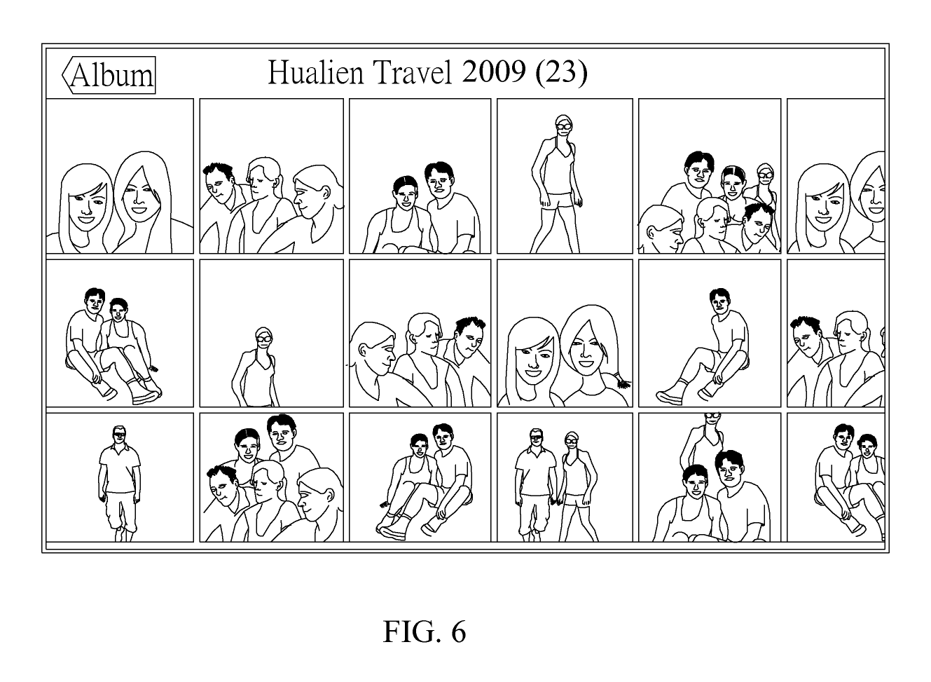

Please refer to FIG. 6. FIG. 6 shows a schematic diagram of the image saved in the specific folder in the electronic device with camera function. While users touch the specific folder name 42, the processing module 13 generates the corresponding command to the touch screen 12 and the image database 14 to link the corresponding folder saved in the image database 14. Therefore, the touch screen 12 will display those images in the folder. In the embodiment of this invention,

While users touch the folder name 42 “Hualian Trip 2009” in the display of image information 40 in the FIG. 4, the processing module 13 will generate the corresponding command to display all images saved in the folder “Hualian Trip 2009” in the image database 14 as the thumbnail format on the touch screen 12. As shown in the FIG. 6, the touch screen 12 displays 23 images in the folder “Hualian Trip 2009” for users to browse images of some specific topics.

If users touch the shooting time information 43 of the display of image information 40, the touch screen 12 can display images in the folder “Hualian Trip 2009” in the thumbnail format and the timeline for users to browse images.

If users touch the shooting location information 44 of the display of image information 40, the processing module 13 will generate the corresponding command to the touch screen 12 and the image database 14 to display those images in the same shooting location in the image database 14 on the touch screen 12. For example, the shooting location information 44 in the FIG. 4 is in Hualian. While users touch the shooting location information 44, any images including the shooting location information in Hualian will be shown regardless of the shooting time.

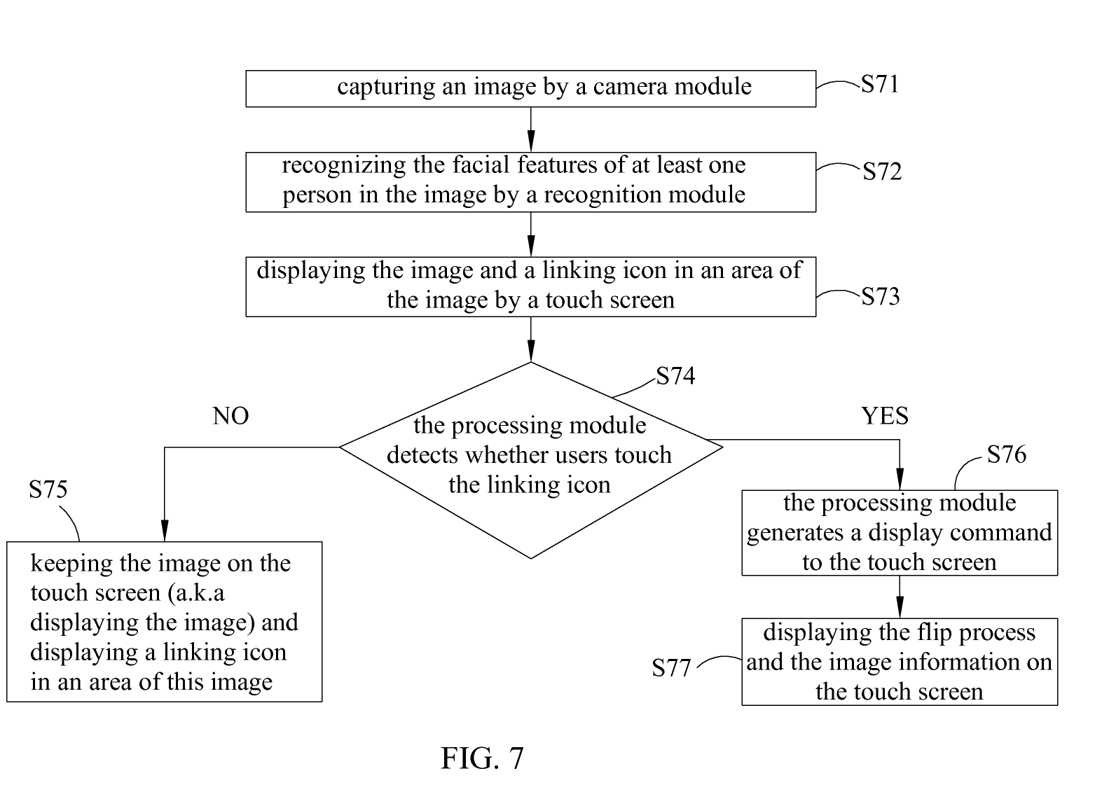

Please refer to FIG. 7. FIG. 7 shows a flowchart of an image information display method combined facial recognition in accordance with an embodiment of the present invention. In FIG. 7, the image information display method combined facial recognition comprises the following steps of: (S71) using the camera module to capture an image; (S72) using the recognition module to recognize facial features in the image; (S73) using the touch screen to display the image and a linking icon in an area of the image; (S74) the processing module detects whether users touch the linking icon. If the process module doesn't detect that users touch the linking icon, it then goes on (S75) keeping the image on the touch screen (a.k.a displaying the image) and displaying a linking icon in an area of this image. Otherwise, the process module goes on (S76) generating a display command to the touch screen. Next, (S77) displaying the flip process and the image information comprising one part of the image, a folder name, shooting time information, shooting location information, the first person information icon, and the second person information icon of the image.

In sum, with the image information display method combined with facial recognition and the electronic device with camera function thereof, users may be able to easily acquire information regarding an image while browsing the image, thereby increasing convenience to users of the electronic device.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiment(s) of the present invention.

What is claimed is:

1. An electronic device with camera function, comprising:
a camera module capturing an image;
a recognition module recognizing at least one facial feature of at least one person in the image;
a touch screen displaying the image and a linking icon in an area of the image; and
a processing module being electrically connected to the camera module, the recognition module and the touch screen; the processing module generating a display command to the touch screen while detecting that the linking icon is touched; the touch screen showing a flip process and then displaying image information according to the display command.

2. The electronic device with camera function as recited in claim 1, wherein the image information further comprises one part of the image, a folder name, a shooting time information, a shooting location information or at least one personal information of the image.

3. The electronic device with camera function as recited in claim 1, wherein the image information further comprises an audio playback icon; the processing module generates a play command to an audio playback module to play audio data while detecting that the audio playback icon is touched.

4. The electronic device with camera function as recited in claim 1, further comprising a contact database electrically connected to the processing module; the processing module generating an add-in icon to at least one person icon on the touch screen while determining that the personal information is not saved in the contact database.

5. The electronic device with camera function as recited in claim 4, wherein while detecting that the add-in icon is touched, the processing module saves the at least one personal information in the contact database.

6. An image information display method combined with facial recognition, comprising the following steps:
capturing an image by a camera module;
recognizing at least one facial feature of at least one person in the image by a recognition module;
displaying the image and a linking icon in an area of the image by a touch screen;
generating a display command to the touch screen while a processing module detects that the linking icon is touched; and
showing a flip process and displaying image information on the touch screen according to the display command.

7. The image information display method combined with facial recognition as claimed in claim 6, wherein the image information further comprises one part of the image, a folder name, a shooting time information, a shooting location information or at least one personal information of the image.

8. The image information display method combined with facial recognition as claimed in claim 6, further comprising the following steps:
generating a play command to an audio playback module by the processing module while the processing module detects that an audio playback icon is touched; and
playing audio data by the audio playback module.

9. The image information display method combined with facial recognition as claimed in claim 6, further comprising the following steps:
generating an add-in icon to at least one person icon on the touch screen by the processing module while the processing module determines that the personal information is not saved in a contact database.

10. The image information display method combined with facial recognition as claimed in claim 9, further comprising the following steps:
saving the at least one personal information in the contact database by the processing module while the processing module detects that the add-in icon is touched.
